(19) United States
(12) Patent Application Publication
(10) Pub. No.: US 2012/0129002 A1
(43) Pub. Date: May 24, 2012

(54) ALUMINUM ARTICLE AND METHOD FOR MANUFACTURING SAME

(75) Inventors: HSIN-PEI CHANG, Tu-Cheng (TW); WEN-RONG CHEN, Tu-Cheng (TW); HUANN-WU CHIANG, Tu-Cheng (TW); CHENG-SHI CHEN, Tu-Cheng (TW); HUA-YANG XU, Shenzhen (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/165,334

(22) Filed: Jun. 21, 2011

(30) Foreign Application Priority Data
Nov. 18, 2010 (CN) 201010549128.5

(51) Int. Cl. B32B 7/04; C25F 7/00; C25F 3/04; B32B 5/18; B32B 15/01

(52) U.S. Cl. 428/651; 428/322.7; 428/650; 428/654; 205/640; 205/671; 205/674

(57) ABSTRACT

An aluminum article includes a substrate comprising a surface having a plurality of nano-pores defined therein; and a transparent vacuum deposition layer deposited on the surface and filling the nano-pores.

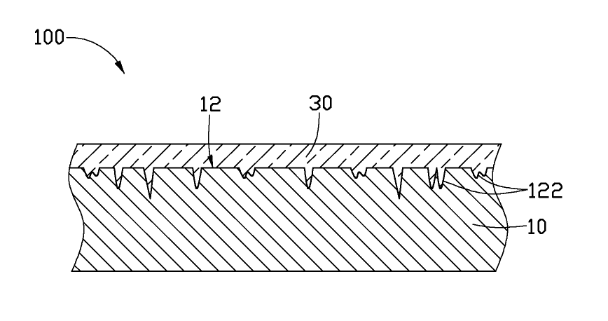

### CROSS-REFERENCE TO RELATED APPLICATIONS

The present application is related to co-pending U.S. Patent Applications (Attorney Docket No. US35006, US35007), each entitled “ALUMINUM ARTICLE AND METHOD FOR MANUFACTURING SAME”, by Zhang et al. These applications have the same assignee as the present application and have been concurrently filed herewith. The above-identified applications are incorporated herein by reference.

### BACKGROUND

1. Technical Field

The exemplary disclosure generally relates to aluminum articles and methods for manufacturing the aluminum articles.

2. Description of Related Art

Aluminum is remarkable for the metal's low density and good machining property. Article made from aluminum and aluminum alloys are vital in the aerospace industry in addition to other areas of transportation, building and electronic device housings. To improve the appearance of aluminum or aluminum alloy articles, vacuum deposition is used to form a thin film or coating on aluminum or aluminum alloy articles. However, a typical vacuum deposition can only deposit mono-color coatings.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the exemplary embodiment of an aluminum article and method for manufacturing the aluminum article. Moreover, in the drawings like reference numerals designate corresponding parts throughout the several views. Wherever possible, the same reference numbers are used throughout the drawings to refer to the same or like elements of an embodiment.

The FIGURE illustrates a cross-sectional view of an embodiment of an aluminum article.

### DETAILED DESCRIPTION

Referring to the FIGURE, an exemplary embodiment of an aluminum article 100 includes a substrate 10 and a transparent vacuum deposition layer 30 deposited on the substrate 10. The aluminum article 100 may be a housing of an electronic device. The substrate 10 is made of aluminum or aluminum alloy. The substrate 10 includes a surface 12 having a plurality of nano-pores 122 defined therein. Each nano-pore 122 may have a different pore opening size from that of at least one of other nano-pores 122, and each nano-pore 122 has a pore opening size between 10 nanometers (nm) and 300 nm, preferably between 30 nm and 100 nm. Each nano-pore 122 may have a depth different from that of at least one of other nano-pores 122, and each nano-pore 122 has a depth between 10 nm and 120 nm, preferably between 20 nm and 80 nm. The nano-pores 122 may be formed by electro-chemical corrosion.

The vacuum deposition layer 30 is deposited on the surface 12, and the nano-pores 122 are filled by the vacuum deposition layer 30. The vacuum deposition layer 30 may be deposited by metal, metal-oxide or non-metal oxide. The metal may be titanium, chromium, aluminum or zirconium. The metal-oxide may be titanium-oxide, chromium-oxide, aluminum-oxide or zirconium-oxide. The non-metal oxide may be silicone oxide. When the vacuum deposition layer 30 is deposited by metal, the thickness of the vacuum deposition layer 30 is between 10 nm and 150 nm because when the thickness of the vacuum deposition layer 30 is thicker than 150 nm, the vacuum deposition layer 30 becomes non-transparent. However, when the thickness of the vacuum deposition layer 30 is thinner than 150 nm, the vacuum deposition layer 30 is transparent. When the vacuum deposition layer 30 is deposited by metal-oxide or non-metal oxide, the thickness of vacuum deposition layer 30 is between the 50 nm and 2 micrometers.

Due to the fact that each nano-pore 122 has a depth different from that of at least one of other nano-pores 122, the thickness of one place of the vacuum deposition layer 30 may be different from the thickness of other places of the vacuum deposition layer 30. For example, portions of the vacuum deposition layer 30 deposited on the surface 12 may be thinner than the reminder of the vacuum deposition layer 30 deposited in the nano-pores 122, and this also can be seen in the FIGURE. Because optical path differences is different according to different thicknesses of the vacuum deposition layer 30, different colors would be appear at different thicknesses of the vacuum deposition layer 30 when the vacuum deposition layer 30 is illuminated by light. Thus, the aluminum article 100 can be appeared multi-color seeing from the surface 12.

A method for manufacturing the aluminum article 100 manufactured by vacuum deposition may include at least the following steps.

A substrate 10 including a surface 12 is provided. The substrate 10 may be made of aluminum or aluminum alloy.

The substrate 10 is pretreated. For example, the substrate 10 may be washed with a solution (e.g., alcohol) for about 5 minutes, and then is washed with an acetone in an ultrasonic cleaner for about 30 minutes, to remove grease, dirt, and/or impurities. Thereafter, the substrate 10 is washed by water, followed by drying. The substrate 10 may also be cleaned using chemical polishing with a solution including phosphorous acid of 85 wt %, nitric acid and water, at a temperature between 70 degree Celsius (° C.) and 80 ° C., for about 5 minutes.

The substrate 10 is treated by anode electro-chemical corrosion to form a plurality of nano-pores 122 on the surface 12. The substrate 10 acts as an anode pole and the titanium board acts as a cathode pole. Hydrofluoric Acid of 0.5% wt % and sulphuric acid of 0.5 mol/L are used as an electrolyte, the temperature of the electrolyte is ambient temperature, the pH value of the electrolyte is less than 2, the electrolysis voltage of the electrolyte is between 10 volts and 25 volts, the electrolysis time of the electrolyte is between 30 minutes and 100 minutes. During the electrolysis, the electrolyte may be stirred by a magnetic stirrer.

The substrate 10 is treated by vacuum deposition, to form the vacuum deposition layer 30 on the substrate 10. The vacuum deposition may be a vacuum sputtering deposition or a vacuum evaporation. The thickness of the vacuum deposition layer 30 can be controlled in the range previously mentioned by controlling the time of the vacuum deposition, to ensure the vacuum deposition layer 30 is transparent.

It is to be understood, however, that even through numerous characteristics and advantages of the exemplary disclosure have been set forth in the foregoing description, together with details of the system and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An aluminum article, comprising:
a substrate comprising a surface having a plurality of nano-pores defined therein; and
a transparent vacuum deposition layer deposited on the surface and filling the nano-pores.

2. The aluminum article as claimed in claim 1, wherein the nano-pores are formed by electro-chemical corrosion.

3. The aluminum article as claimed in claim 1, wherein the substrate is made of aluminum or aluminum alloy.

4. The aluminum article as claimed in claim 1, wherein each nano-pore has a different pore opening size from that of at least one of other nano-pores.

5. The aluminum article as claimed in claim 1, wherein each nano-pore has a pore opening size between 10 nanometers and 300 nanometers.

6. The aluminum article as claimed in claim 5, wherein each nano-pore has a pore opening size between 30 nanometers and 100 nanometers.

7. The aluminum article as claimed in claim 1, wherein each nano-pore has a depth different from that of at least one of other nano-pores.

8. The aluminum article as claimed in claim 1, wherein each nano-pore has a depth between 10 nanometers and 120 nanometers.

9. The aluminum article as claimed in claim 8, wherein each nano-pore has a depth between 20 nanometers and 80 nanometers.

10. The aluminum article as claimed in claim 1, wherein the vacuum deposition layer is deposited by metal, metal-oxide or non-metal oxide.

11. The aluminum article as claimed in claim 10, wherein the metal is titanium, chromium, aluminum or zirconium.

12. The aluminum article as claimed in claim 10, wherein the metal-oxide is titanium-oxide, chromium-oxide, aluminum-oxide or zirconium-oxide.

13. The aluminum article as claimed in claim 10, wherein the non-metal oxide is silicone oxide.

14. The aluminum article as claimed in claim 10, wherein when the vacuum deposition layer is deposited by metal, the thickness of the vacuum deposition layer is between 10 nanometers and 150 nanometers.

15. The aluminum article as claimed in claim 10, wherein when the vacuum deposition layer is deposited by metal-oxide or non-metal oxide, the thickness of vacuum deposition layer is between the 50 nanometers and 2 micrometers.

16. A method for manufacturing an aluminum article comprising steps of:
providing a substrate comprising a surface;
forming a plurality of nano-pores in the surface; and
forming a transparent vacuum deposition layer on the surface by vacuum depositing, the transparent vacuum deposition layer filling the nano-pores.

17. The method of claim 16, wherein the substrate is made of aluminum or aluminum alloy.

18. The method of claim 16, wherein the substrate is treated by anode electro-chemical corrosion, to form the nano-pores on the surface.

19. The method of claim 18, wherein during the substrate is treated by anode electro-chemical corrosion, the substrate acts as anode pole, a titanium board acts as cathode pole; hydrofluoric Acid of 0.5% wt % and sulphuric acid of 0.5 mol/L are used as an electrolyte, a temperature of the electrolyte is ambient temperature, a pH value of the electrolyte is less than 2, a electrolysis voltage of the electrolyte is between 10 volts and 25 volts, an electrolysis time of the electrolyte is between 30 minutes and 100 minutes.

20. The method of claim 18, wherein during the electrolysis, the electrolyte is stirred by a magnetic stirrer.
